(19) United States
(12) Patent Application Publication
(10) Pub. No.: US 2026/0091601 A1
(43) Pub. Date: Apr. 2, 2026

(54) MEDIUM PRESSING MEMBER AND PRINTING APPARATUS

(71) Applicant: SEIKO EPSON CORPORATION, Tokyo (JP)

(72) Inventor: Shu TSUCHIYA, SHIOJIRI-SHI (JP)

(21) Appl. No.: 19/339,644

(22) Filed: Sep. 25, 2025

(30) Foreign Application Priority Data
Sep. 27, 2024 (JP) 2024-168300

(51) Int. Cl. B41J 15/04; B41J 15/02; B41J 15/08

(52) U.S. Cl. CPC B41J 15/046; B41J 15/02; B41J 15/08; B41J 2203/01

(57) ABSTRACT

According to an aspect of the present disclosure, there is provided a medium pressing member including medium holding units configured to press an end portion of a medium conveyed in a conveyance direction along a support surface of a medium support unit to sandwich, with the support surface, the end portion of the medium in an intersection direction intersecting the conveyance direction and a main body unit configured to support the medium holding units and capable of engaging with the medium support unit. The medium holding units or the main body unit includes light passing sections, and irradiation light that is emitted from an optical sensor that performs scanning in the intersection direction and is for detecting a detection object on the support surface passes the light passing sections.

The present application is based on, and claims priority from JP Application Serial Number 2024-168300, filed September 27, 2024, the disclosure of which is hereby incorporated by reference herein in its entirety.

### BACKGROUND

### Technical Field

The present disclosure relates to a medium pressing member and a printing apparatus.

### Related Art

In the related art, a medium pressing member that holds roll paper or the like on a platen is known. As a member explained above, there is a member that is variously devised in order to facilitate detection of a position by an optical sensor or the like. For example, JP-A-2023-114964 discloses a printing apparatus including a medium clamp having a recognition pattern.

JP-A-2023-114964 is an example of the related art.

However, the medium clamp described in JP-A-2023-114964 has a problem in that it is difficult to correctly detect the recognition pattern. Specifically, dust deriving from an installation environment of the printing apparatus, ink mist generated from a print head, and the like sometimes adhere to the recognition pattern. Stains of the recognition pattern make optical detection difficult and is likely to induce erroneous detection. That is, there is a demand for a medium pressing member that suppresses occurrence of erroneous detection.

### SUMMARY

According to an aspect of the present disclosure, there is provided a medium pressing member including: a medium holding unit configured to press an end portion of a medium conveyed in a conveyance direction along a support surface of a medium support unit to sandwich, with the support surface, the end portion of the medium in an intersection direction intersecting the conveyance direction; and a main body unit configured to support the medium holding unit and capable of engaging with the medium support unit, in which the medium holding unit or the main body unit includes a light passing section, and irradiation light that is emitted from an optical sensor that performs scanning in the intersection direction and is for detecting a detection object on the support surface passes the light passing section.

According to an aspect of the present disclosure, there is provided a printing apparatus including: a medium support unit configured to support, on a support surface, a medium conveyed in a conveyance direction; a head configured to discharge liquid onto the medium supported on the support surface; a head carriage configured to move the head in an intersection direction intersecting the conveyance direction; an optical sensor mounted on the head carriage and performs scanning in the intersection direction to detect a detection object on the support surface; and a medium pressing member including a medium holding unit configured to press an end portion of the medium in the intersection direction to sandwich the end portion with the support surface and a main body unit configured to support the medium holding unit and capable of engaging with the medium support unit, in which the medium holding unit or the main body unit includes a light passing section configured to allow irradiation light of the optical sensor to pass.

### BRIEF DESCRIPTION OF THE DRAWINGS

FIG. 1 is a schematic diagram illustrating a configuration of a printing apparatus according to a first embodiment.

FIG. 2 is a perspective view illustrating disposition of a medium pressing member, an optical sensor, and the like.

FIG. 3 is a side view illustrating the disposition of the medium pressing member, the optical sensor, and the like.

FIG. 4 is a perspective view illustrating a configuration of the medium pressing member.

FIG. 5 is a perspective view illustrating a configuration of the medium pressing member.

FIG. 6 is a schematic diagram illustrating another form of a light passing section.

FIG. 7 is an enlarged plan view illustrating detailed disposition and dimensions of the light passing section.

FIG. 8 is a schematic diagram of an output signal of the optical sensor.

FIG. 9 is a perspective view illustrating a configuration of a medium pressing member according to a second embodiment.

FIG. 10 is a side view illustrating the configuration of the medium pressing member.

FIG. 11 is a schematic diagram of an output signal of an optical sensor according to a comparative example.

### DESCRIPTION OF EMBODIMENTS

In an embodiment explained below, a medium pressing member and a printing apparatus 1 including the medium pressing member are exemplified and explained with reference to the drawings. The printing apparatus 1 is a large printer that performs printing on a continuous ledger-like sheet. The medium pressing member of the present disclosure is not limited to being provided in the printing apparatus. The printing apparatus of the present disclosure is not limited to a configuration explained below.

In the figures referred to below, X, Y, and Z axes are added as coordinate axes orthogonal to one another, direction pointed by arrows are represented as + directions and directions opposite to the + directions are represented as - directions. When the printing apparatus 1 is installed on the horizontal plane, a -Z direction is the vertical direction. In the following explanation, a +Z direction is sometimes referred to as upward and the -Z direction is sometimes referred to as downward. In the figures referred to below, sizes of members are differentiated from actual sizes for convenience of illustration.

### 1. First Embodiment

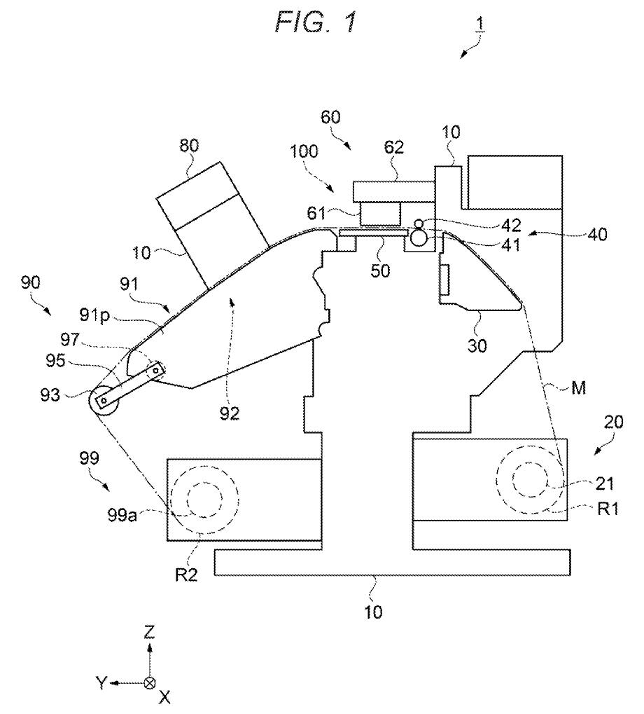

As illustrated in FIG. 1, the printing apparatus 1 according to the present embodiment includes a structural member 10, a letting-out unit 20, a medium sliding member 30, a medium support unit 50, a conveyance roller pair 40, a printing unit 60, an air blowing unit 80, and a medium conveyance unit 90. Although not illustrated, the printing apparatus 1 also includes a control unit and a housing.

In FIG. 1, for convenience of illustration, a housing that houses the printing unit 60 and the like is omitted. In the following referring to FIG. 1, unless specifically noted otherwise, a state viewed from a -X direction is explained.

The printing apparatus 1 deposits ink on a medium M, which is a continuous ledger-like sheet, to manufacture a print. In the printing apparatus 1, the medium M is let out from a roll body R1, which is an original sheet roll, to be a print and the print is wound to be a roll body R2.

The control unit is electrically coupled to the components of the printing apparatus 1 to integrally control operations of the components. The control unit includes hardware such as a central processing unit (CPU), a read only memory (ROM), and a random access memory (RAM). The control unit controls the printing apparatus 1 by executing a predetermined control program with the CPU. The ROM is a nonvolatile storage device and stores the control program to be executed by the CPU and data to be processed by the control program. The RAM configures a work area of the CPU. The CPU loads the control program read from the ROM or the like in the RAM and executes the loaded control program to control the printing apparatus 1.

A movement path of the medium M from being let out from the roll body R1 until being wound as the roll body R2 is represented as a conveyance path. In FIG. 1, the conveyance path is displayed by an alternate long and short dash line. In the conveyance path, an original sheet roll side of the medium M is also referred to as upstream and a side to which the medium M and a print advance is also referred to as downstream. In the conveyance path, the letting-out unit 20, the medium sliding member 30, the conveyance roller pair 40, the medium support unit 50 and the printing unit 60, the medium conveyance unit 90, and the air blowing unit 80 are disposed in this order from upstream to downstream. In the conveyance path, a direction in which the medium M moves from upstream to downstream is also referred to as conveyance direction and a direction intersecting the conveyance direction is also referred to as intersection direction.

The structural member 10 is a frame that supports the components explained above of the printing apparatus 1. The structural member 10 is formed by assembling a plurality of sheet metal members, tubular members, and the like. In the structural member 10, casters, installation members, or the like may be disposed at portions in contact with a floor below the structural member 10.

The letting-out unit 20 includes a roll body holding unit 21. The letting-out unit 20 is disposed in a -Y direction below the printing apparatus 1. The roll body holding unit 21 supports the roll body R1 to be capable of rotating centering on an axis extending along the X axis. The medium M is pulled by the conveyance roller pair 40 to be let out downstream from the roll body R1 and is supplied. The roll body R1 is detachably attachable to the printing apparatus 1. The medium M is conveyed substantially upward from the roll body holding unit 21 by the conveyance roller pair 40 and advances to the medium sliding member 30.

The medium M is selected as appropriate according to a type of ink to be deposited on the medium M, a use of a print, and the like. In the printing apparatus 1, for example, so-called soft solvent ink is applied as the ink. In this case, a polyvinyl chloride sheet or the like is used as the medium M.

The medium sliding member 30 has a substantially arc-shaped curved surface and supports the conveyed medium M. The conveyance direction of the medium M is changed from a substantially upward direction to a substantially +Y direction by the curved surface of the medium sliding member 30. The medium M is conveyed while sliding in contact with the curved surface of the medium sliding member 30. The medium M advances from the medium sliding member 30 to the conveyance roller pair 40.

Although not illustrated, the medium sliding member 30 incorporates an electric heater that heats the medium M. The electric heater heats, in advance, the medium M before the ink being deposited thereon. Accordingly, fixability, solubility, and the like of the ink with respect to the medium M are improved.

The conveyance roller pair 40 includes conveyance rollers 41 and 42. The conveyance rollers 41 and 42 form a pair and side surfaces thereof are in contact with each other. The conveyance roller 41 is disposed below the conveyance path and the conveyance roller 42 is disposed above the conveyance path. The conveyance rollers 41 and 42 respectively rotate centering on axes extending along the X axis.

The conveyance roller 41 is driven by a not-illustrated drive motor to rotate. The conveyance roller 42 is a driven roller and rotates in a direction opposite to a rotating direction of the conveyance roller 41 according to the rotation of the conveyance roller 41. When the conveyance roller 41 rotates counterclockwise, the conveyance roller 42 rotates clockwise. Accordingly, the medium M is nipped between the conveyance rollers 41 and 42 and conveyed downstream. Then, the medium M advances to the medium support unit 50.

The medium support unit 50 includes a not-illustrated support surface. The medium support unit 50 is a member configuring a so-called platen. The length along the X axis of the medium support unit 50 is larger than the length along the X axis of the medium M. The support surface is a surface facing upward of the medium support unit 50 and extends along an XY plane. The medium support unit 50 supports, on the support surface, the medium M conveyed in the conveyance direction. The medium M is conveyed in a +Y direction, which is the conveyance direction, along the support surface of the medium support unit 50. In the medium support unit 50, a surface facing upward of the medium M is a printing surface.

The printing apparatus 1 includes medium pressing members 100. The medium pressing members 100 press both end portions in a direction along the X axis, which is the intersection direction, in the medium M. Two medium pressing members 100 are disposed in the medium support unit 50 to correspond to an end portion in a +X direction of the medium M and an end portion in a -X direction of the medium M. The medium M is conveyed in the +Y direction, which is the conveyance direction in the medium support unit 50, while being pressed against the medium support unit 50 by the medium pressing members 100. Details of the medium pressing members 100 are explained below.

Although not illustrated, the medium support unit 50 incorporates an electric heater that heats the medium M. The electric heater heats the medium M when ink is deposited on the medium M. Accordingly, fixability, solubility, and the like of the ink with respect to the medium M are improved and a volatile component such as a solvent contained in the ink easily volatilizes.

The printing unit 60 performs printing on the medium M. The printing unit 60 includes a head 61, a head carriage 62, and a not-illustrated optical sensor. The printing unit 60 is disposed above the medium support unit 50.

The head carriage 62 is supported above the structural member 10 to be capable of reciprocating along the X axis. The movement of the head carriage 62 is driven by a not-illustrated head carriage motor. The head carriage 62 supports the head 61 above the medium support unit 50 and reciprocates the head 61 in the direction along the X axis, which is the intersection direction. The optical sensor is disposed in the head carriage 62. Details of the optical sensor are explained below.

The head 61 discharges and deposits ink, which is liquid, on the printing surface of the medium M supported by the support surface of the medium support unit 50. The head 61 reciprocates, together with the carriage 62, along the X axis in a range including a region facing the medium support unit 50 in the up-down direction.

Although not illustrated, a nozzle surface is disposed on a surface facing downward of the head 61. A plurality of nozzle arrays are provided on the nozzle surface. The nozzle arrays include pluralities of nozzles that discharge inks. Inks assuming colors such as black, cyan, yellow, and magenta are individually supplied to the nozzle arrays from not-illustrated ink storage containers. The color inks are discharged from the nozzle arrays, respectively, toward the printing surface of the medium M.

The ink applied to the printing apparatus 1 is the soft solvent ink as explained above. The soft solvent ink is, for example, a solvent ink that does not contain intentionally added water and contains a glycol ether-based solvent, a lactone-based solvent, or the like as a main solvent. The liquid discharged by the head 61 may include treatment liquid, clear ink not containing a color material, and the like.

The medium support unit 50 reciprocates the head 61 along the X axis together with the head carriage 62 while conveying the medium M in the +Y direction. At this time, an image such as a picture, a photograph, a text, or a pattern is printed on the medium M by depositing the ink on the printing surface of the medium M at any timing. The medium M to which printing has been applied advances to the medium conveyance unit 90 and the air blowing unit 80 downstream.

The medium conveyance unit 90 includes a medium sliding unit 91, a heating unit 92, a tension bar 93, arm units 95, turning units 97, and a winding unit 99.

The components of the medium conveyance unit 90 are supported by the structural member 10 and are disposed in the +Y direction of the printing apparatus 1. In the medium conveyance unit 90, the medium sliding unit 91, the tension bar 93, and the winding unit 99 are disposed in this order in the conveyance direction.

The medium sliding unit 91 has a curved surface, which supports the medium M, and supports the conveyed medium M. The curved surface of the medium sliding unit 91 faces substantially upward in the medium sliding unit 91. The medium M is conveyed while sliding in contact with the curved surface of the medium sliding unit 91. In the direction along the X axis, the length of the curved surface of the medium sliding unit 91 is larger than the length of the medium M. The conveyance direction of the medium M is changed from the +Y direction to the +Y direction and a slightly downward direction by the curved surface of the medium sliding unit 91.

The medium sliding unit 91 includes a pair of side walls 91p. The side walls 91p are respectively disposed at an end portion in the +X direction and an end portion in the -X direction of the medium sliding unit 91. The side walls 91p are substantially plate-shaped members and are formed of, for example, sheet metals. The side walls 91p include surfaces that extend along a YZ plane and intersect the curved surface of the medium sliding unit 91.

The medium sliding unit 91 includes the heating unit 92. The heating unit 92 is an electric heater and heats the medium M. The heating unit 92 is disposed on the inner side of the curved surface of the medium sliding unit 91. The heating unit 92 promotes volatilization of a volatile component contained in the ink deposited on the medium M. Accordingly, when the medium M is wound on the roll body R2 by the winding unit 99, an ink component can be prevented from adhering to other places.

The air blowing unit 80 blows air to the printing surface of the medium M to assist the volatilization of the volatile component. The air blowing unit 80 is supported by the structural member 10 above the conveyance path of the medium sliding unit 91. The air blowing unit 80 blows air to the entire range along the X axis of the medium M.

Drying of the ink deposited on the medium M is promoted by the heating by the heating unit 92 and the air blowing by the air blowing unit 80. For that reason, the medium M can be wound by the winding unit 99 downstream. The medium M is pulled and conveyed by the winding unit 99 and advances to the tension bar 93.

The tension bar 93 applies tension to the medium M between the medium sliding unit 91 and the winding unit 99. The tension bar 93 is a substantially cylindrical member and is disposed with the length direction of a cylinder being along the X axis. An end portion in the -X direction and an end portion in the +X direction of the tension bar 93 are respectively supported by the arm units 95. The tension bar 93 is supported by a pair of arm units 95 and protrudes slightly downward in the +Y direction from the medium sliding unit 91.

In the printing apparatus 1, since the tension bar 93 protrudes downward and slightly in the +Y direction from the medium sliding unit 91, the medium M is conveyed while being pushed in the substantially +Y direction by the tension bar 93. Accordingly, the medium M is wound by the winding unit 99 while tension being applied thereto.

A surface equivalent to a side surface of the cylinder of the tension bar 93 is formed smooth with relatively low frictional resistance. For that reason, the medium M slides on a side surface of the tension bar 93 even if tension is applied thereto. The side surface of the cylinder of the tension bar 93 may be covered with a sheet-shaped member that comes into contact with the medium M. The tension bar 93 does not rotate with respect to the arm unit 95.

The arm units 95 are substantially rod-shaped members. In a state in which the tension bar 93 functions, the arm units 95 support the tension bar 93 at one ends in the substantially +Y direction. The other ends of the arm units 95 in the substantially -Y direction are turnably supported by the turning units 97.

In a plan view from above, length that is the distance between the one ends and the other ends of the arm units 95 is smaller than the length in the conveyance direction of the medium sliding unit 91. Accordingly, since the arm units 95 and the like are relatively small, the medium conveyance unit 90 can be further reduced in size.

The turning units 97 are disposed to correspond to the respective arm units 95. Specifically, the turning units 97 are provided on a side wall 91p in the +X direction and a side wall 91p in the -X direction in the medium sliding unit 91. A pair of turning units 97 turn clockwise and counterclockwise centering on the vicinities of the other ends of each arm unit 95 according to driving of a not-illustrated driving unit.

For that reason, the one ends of the arm units 95 turn clockwise and counterclockwise while supporting the tension bar 93. Accordingly, the position, particularly, the protrusion distance in the +Y direction of the tension bar 93 changes and the strength of the tension applied to the medium M is adjusted. Specifically, when the tension bar 93 turns clockwise, the protrusion distance in the +Y direction of the tension bar 93 from the medium sliding unit 91 increases and the medium M is pushed in the +Y direction and strong tension is applied to the medium M. When the tension bar 93 turns counterclockwise, the protrusion distance in the +Y direction of the tension bar 93 from the medium sliding unit 91 decreases and a force of pushing the medium M in the +Y direction weakens and the applied tension is reduced.

The turning units 97 are provided at a position closer to the end portion in the +Y direction, which is the downstream end, than the end portion in the -Y direction, which is the upstream end, of the medium sliding unit 91 with respect to the conveyance direction of the medium M. Accordingly, the length of the arm units 95 is reduced compared with when the turning units 97 are provided close to the upstream end of the medium sliding unit 91. For that reason, the size of the medium conveyance unit 90 is more easily reduced and the weight and cost of the apparatus are further reduced.

The conveyance direction of the medium M is changed from a downward direction in the +Y direction to a downward direction in the -Y direction by the tension bar 93. The medium M advances to the winding unit 99 through the tension bar 93.

The winding unit 99 winds the medium M on the roll body R2. The winding unit 99 includes a roll body holding unit 99a. The winding unit 99 is disposed in the +Y direction below the printing apparatus 1. The roll body holding unit 99a rotates counterclockwise according to rotational driving of a not-illustrated drive motor and winds the medium M as the roll body R2. At this time, the roll body R2 rotates centering on an axis extending along the X axis.

When the medium M is wound on the roll body R2, winding accuracy is improved by tension applied by the tension bar 93. For that reason, positional deviation of both ends along the X axis of the medium M is reduced and the roll body R2 with both the ends relatively aligned is obtained. In addition, a gap between stacked media M is reduced by the applied tension and an elaborated roll body R2 is obtained. The strength of the tension applied to the medium M has an appropriate range. The tension is set as appropriate according to a type, dimensions, and the like of the medium M.

According to the above, the medium M, which is a print, becomes the roll body R2. The roll body R2 can be detached from the printing apparatus 1 substantially in the +Y direction. The print of the printing apparatus 1 is applied to a signage use or the like.

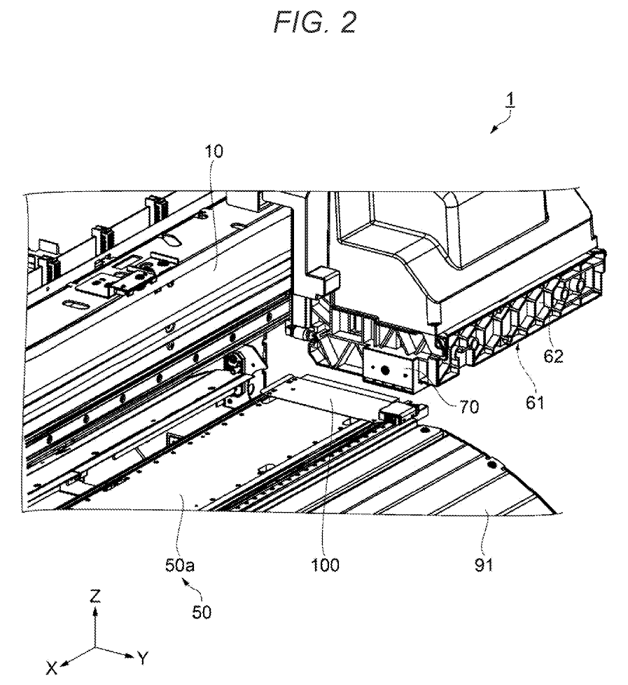

As illustrated in FIG. 2, an optical sensor 70 is mounted on a side surface in the +X direction of the head carriage 62. The optical sensor 70 is also supported by the head carriage 62 and reciprocates along the X axis. The optical sensor 70 and the nozzle surface of the head 61 face the support surface 50a of the medium support unit 50 in the up-down direction. In FIG. 2, illustration of some of the components of the printing apparatus 1 is omitted.

The optical sensor 70 performs scanning in the direction along the X axis, which is the intersection direction and detects a detection object on the support surface 50a. The detection object referred to here indicates the not-illustrated medium M and the medium pressing members 100 supported by the support surface 50a. The optical sensor 70 is, for example, a reflective sensor and includes a light emitting unit and a light receiving unit explained below. The reflective sensor emits light from the light emitting unit in the -Z direction. When the detection object is present on the support surface 50a, the light receiving unit receives reflected light traveling in the +Z direction generated by reflection of the light. The reflective sensor detects presence or absence of the detection object from a change in the intensity of the reflected light and outputs a detection result to the control unit. A commercially available product may be applied as the reflective sensor.

While reciprocating along the X axis, the optical sensor 70 detects the presence or absence of the detection object. The control unit specifies a printable region of the medium M in the direction along the X axis. Accordingly, the printing region is adjusted in the direction along the X axis of the medium M.

As explained above, the medium pressing members 100 press both the ends of the medium M in the direction along the X axis. For that reason, the medium pressing members 100 are installed in the vicinity of the end portion in the +X direction and the end portion in the -X direction in a scanning range of the head carriage 62. In FIG. 2, of the two medium pressing members 100, the medium pressing member 100 on the end portion side in the -X direction is illustrated. The medium pressing members 100 have configurations and forms that are substantially symmetric with respect to a straight line extending along the Y axis for the purpose of enabling use without distinction on both the sides in the direction along the X axis.

A user of the printing apparatus 1 installs the medium pressing members 100 above a side in the +X direction and a side in the -X direction of the medium M as preparation for printing. Accordingly, the medium M is positioned in the direction along the X axis and occurrence of meandering or positional deviation of the medium M is suppressed. The end portion in the X direction of the medium M is prevented from rising to prevent the medium M and the head 61 from coming into contact with each other. For that reason, it is preferable that the length in the Y-axis direction in which the medium pressing members 100 press the medium M is equal to or larger than the length in the Y-axis direction of the head 61.

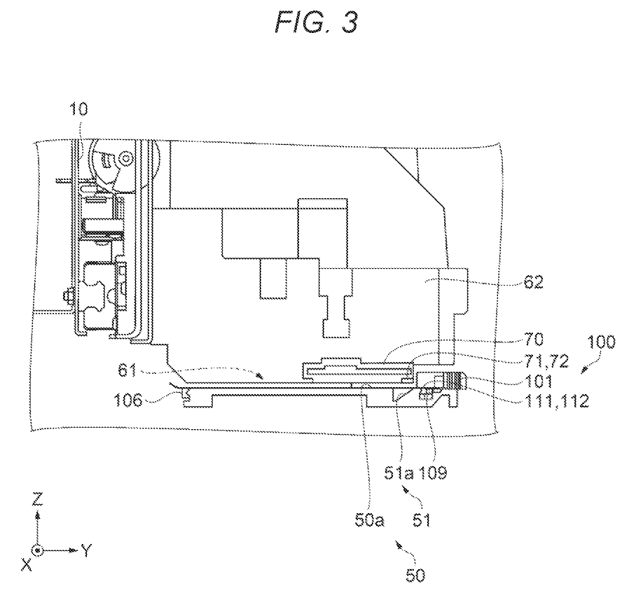

As illustrated in FIG. 3, the medium pressing member 100 includes a main body unit 101, a first engagement unit 106, second engagement units 109, and a not-illustrated medium holding unit. The first engagement unit 106 and the second engagement units 109 are formed in the main body unit 101. The medium holding unit is provided to project from the main body unit 101 in the +X direction and the -X direction. In other words, the medium pressing member 100 is configured with the main body unit 101, the medium holding unit, and the like. The main body unit 101 or the medium holding unit has a light passing section explained below that allows irradiation light of the optical sensor 70 to pass. When viewed from the +X direction, the light emitting unit 71 and the light receiving unit 72 are disposed to face the light passing section in the up-down direction. In the following explanation referring to FIG. 3, unless specifically noted otherwise, a state viewed from the +X direction is explained.

The optical sensor 70 includes a light emitting unit 71 and a light receiving unit 72. The light emitting unit 71 emits irradiation light in the -Z direction and the light receiving unit 72 receives light made incident from the -Z direction. In the reciprocating movement of the optical sensor 70 along the X axis, when the light emitting unit 71 comes to a position facing the light passing section in the up-down direction, the irradiation light of the light emitting unit 71 passes the light passing section and travels in the -Z direction. In contrast, when the light emitting unit 71 comes to a region other than the light passing section of the medium pressing member 100 and a position facing the medium M in the up-down direction, the irradiation light of the light emitting unit 71 is reflected by the region other than the light passing section and the medium M to be reflected light traveling toward the optical sensor 70. The reflected light travels in the +Z direction and is received by the light receiving unit 72. Here, in the following explanation, a state in which an detection object is absent in the -Z direction of the light emitting unit 71 includes a case in which a light passage region is located in the -Z direction of the light emitting unit 71. The light passing region is a region where the irradiation light of the optical sensor 70 emitted in the -Z direction passes further in the -Z than the support surface 50a.

The medium support unit 50 has a support surface 50a and a recess 51. The recess 51 is disposed at a position overlapping the light emitting unit 71 and the light receiving unit 72 in the up-down direction. The irradiation light of the optical sensor 70 passes the recess 51 further in the -Z direction than the support surface 50a. That is, a part where the recess 51 is formed is the light passing region.

The recess 51 extends along the X axis. In the direction along the X axis, the length of the recess 51 is larger than the length of the medium M and is substantially equal to the length of the support surface 50a. In other words, the recess 51 is a groove extending along the direction along the X axis, which is the intersection direction. When the head carriage 62 reciprocates along the X axis, the light emitting unit 71 and the light receiving unit 72 of the optical sensor 70 perform scanning along the recess 51.

The recess 51, which is the groove, is recessed in the -Z direction with respect to the support surface 50a and is constituted by a surface 51a. The surface 51a has a depression angle when viewed from the +Y direction. In the surface 51a, a part irradiated with the irradiation light extends in a direction intersecting the -Z direction, which is the irradiation direction of the irradiation light. The surface 51a faces the light emitting unit 71 and the light receiving unit 72 in the up-down direction but does not reflect the irradiation light emitted from the light emitting unit 71 to the light receiving unit 72. That is, reflected light of the surface 51a with respect to the irradiation light emitted from the light emitting unit 71 is not made incident on the light receiving unit 72. In the present disclosure, the reflected light indicates specularly reflected light and is considered not to include diffuse reflected light. For that reason, even when the diffuse reflected light reaches the light receiving unit 72, it is preferable that an amount of the diffuse reflected light is equal to or less than an amount of light that is not detected by the optical sensor 70.

Here, the support surface 50a is not limited to including the recess 51. For example, instead of the recess 51, a region of the support surface 50a where the recess 51 is disposed may be processed to less easily reflect the irradiation light. Since the reflected light is not made incident on the light receiving unit 72 as at the time when the irradiation light passes further in the -Z direction than the support surface 50a, the region where the support surface 50a is processed to less easily reflect the irradiation light is also treated as the light passing region. That is, a region where the irradiation light emitted from the light emitting unit 71 is not reflected to the light receiving unit 72 can be referred to as light passing region.

When there is no detection object in the -Z direction of the light emitting unit 71, the irradiation light of the light emitting unit 71 passes further in the -Z direction than the medium pressing member 100 and the support surface 50a. Then, the irradiation light is reflected on the surface 51a of the recess 51 and travels to other than the light receiving unit 72. At this time, the reflected light is not detected by the light receiving unit 72 or the intensity of the reflected light decreases. For that reason, it is specified that a detection object is absent on the support surface 50a. Since the recess 51 does not reflect the irradiation light to the light receiving unit 72, the optical sensor 70 can detect the detection object with high sensitivity.

The first engagement unit 106 and the second engagement units 109 are provided to protrude in the -Z direction and engage with the medium support unit 50. That is, the main body unit 101 is capable of engaging with the medium support unit 50. The first engagement unit 106 is disposed at the end portion in the -Y direction of the medium pressing member 100. The second engagement units 109 are disposed near the end portion in the +Y direction of the medium pressing member 100. The medium pressing member 100 is restricted from moving in the direction along the Y axis with respect to the medium support unit 50 and is not restricted from moving along the X axis with respect to the medium support unit 50. By the first engagement unit 106 and the second engagement units 109, positioning of the medium pressing member 100 in the direction along the Y axis and rising from the support surface 50a are suppressed.

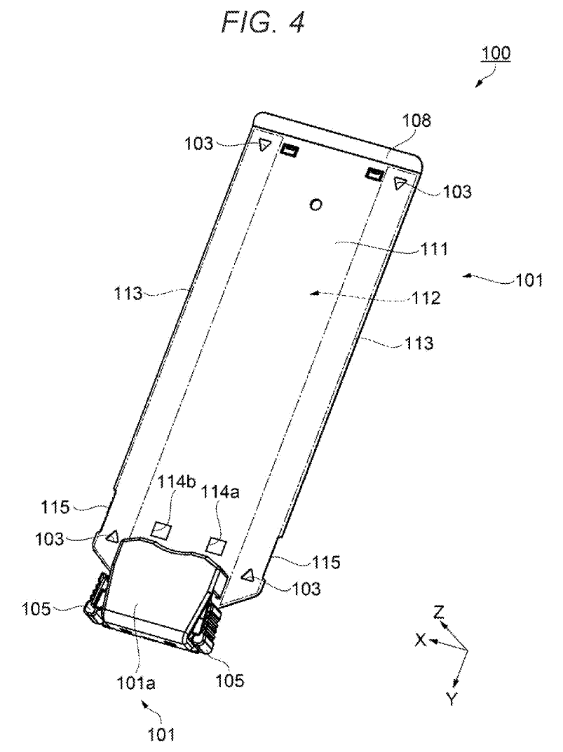

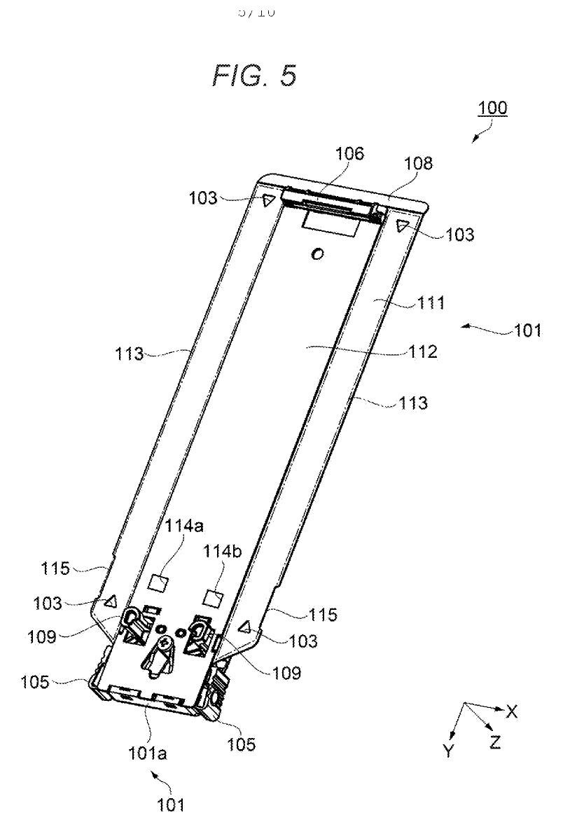

As illustrated in FIGS. 4 and 5, the medium pressing member 100 includes a main body unit 101, guide holes 103, disengagement units 105, and medium holding units 113. The main body unit 101 includes a first sheet metal 111 and a second sheet metal 112 made of metal and an operation unit 101a made of resin and attached to the first sheet metal 111 and the second sheet metal 112. The main body unit 101 supports the medium holding units 113.

The first sheet metal 111 and the second sheet metal 112 are substantially rectangular when viewed from the +Z direction and the longitudinal direction of the first sheet metal 111 and the second sheet metal 112 is along the Y axis. The first sheet metal 111 and the second sheet metal 112 are metal plates having metallic luster and reflect the irradiation light of the light emitting unit 71. The first sheet metal 111 and the second sheet metal 112 are formed of metal such as stainless steel or aluminum.

The first sheet metal 111 and the second sheet metal 112 overlap each other in the direction along the Z axis. The second sheet metal 112 is overlapped in the -Z direction of the first sheet metal 111. Since the first sheet metal 111 and the second sheet metal 112 are overlapped, the mechanical strength of the medium pressing member 100 is improved.

When viewed from the -Z direction, the second sheet metal 112 is smaller than the first sheet metal 111. Specifically, in the direction along the Y axis, the length of the first sheet metal 111 and the length of the second sheet metal 112 are substantially equal. In the direction along the X axis, which is the intersection direction, the width of the second sheet metal 112 is smaller than the width of the first sheet metal 111.

When viewed from the -Z direction, regions that do not overlap the second sheet metal 112 are respectively present near a side in the -X direction and near a side in the +X direction of the first sheet metal 111. The regions are the medium holding units 113. That is, the medium pressing member 100 includes the medium holding units 113 one by one on each the side in the direction along the X axis. The medium holding units 113 have a trapezoidal shape elongated in the direction along the Y axis when viewed from the -Z direction. The medium holding unit 113 in the -X direction and the medium holding unit 113 in the +X direction are symmetric with respect to a straight line along the Y axis.

The width of the first sheet metal 111 in the direction along the X axis and the width of the second sheet metal 112 in the direction along the X axis do not need to have the relationship explained above over the entire region in the direction along the Y axis. Specifically, the relationship explained above only has to hold at least in a region facing a scanning range of the head 61 in the up-down direction. In a region other than the facing region explained above, a part where the width of the second sheet metal 112 is larger than the width of the first sheet metal 111 may be present in the direction along the X axis.

The medium holding units 113 are formed by the first sheet metal 111. The medium holding units 113 press and hold the end portion of the medium M in the direction along the X axis to sandwich the end portion between the medium holding units 113 and the support surface 50a. Specifically, in the medium holding units 113, since the second sheet metal 112 is not overlapped on the first sheet metal 111, the gap between the support surface 50a and the medium holding unit 113 is larger by the thickness of the second sheet metal 112 compared with a part where the first sheet metal 111 and the second sheet metal 112 are superimposed. The medium M is sandwiched in the gap, and the medium M is pressed by the support surface 50a and the medium holding units 113. That is, the main body unit 101 is configured with a portion where the first sheet metal 111 and the second sheet metal 112 overlap and the medium holding unit 113 is configured with the first sheet metal 111 that does not overlap the second sheet metal 112 and projects from the main body unit 101. The medium holding units 113 may be configured with components different from the components configuring the main body unit 101.

The second sheet metal 112 guides the end face of the medium M in the direction along the X axis. Specifically, when the medium holding units 113 press the medium M, a side of the second sheet metal 112 in the direction along the X axis and a side at the end of the medium M in the direction along the X axis come into contact, whereby a part of the medium M is prevented from entering a region other than the medium holding units 113, that is, a region where the first sheet metal 111 and the second sheet metal 112 overlap. Accordingly, positioning of the medium pressing member 100 with respect to the medium M can be easily and steadily performed in the direction along the X axis. When the medium M is pressed by the medium holding units 113, the side of the medium M and the side of the second sheet metal 112 may not come into contact.

As explained above, the medium pressing members 100 are installed at both the ends in the direction along the X axis of the medium M supported by the support surface 50a. For that reason, in the medium pressing member 100 installed in the -X direction of the support surface 50a, the medium M is pressed by the medium holding unit 113 on the +X direction side. In the medium pressing member 100 installed in the +X direction of the support surface 50a, the medium M is pressed by the medium holding unit 113 on the -X direction side.

The medium pressing member 100 restricts the medium M from moving along the X axis but does not restrict the medium M from moving along the Y axis. The medium M can be conveyed in the direction along the Y axis while being pressed by the medium pressing member 100.

The main body unit 101 includes light passing sections 114a and 114b. The light passing sections 114a and 114b are disposed in, in the direction along the Y axis, a region where the light passing sections 114a and 114b are capable of facing the light emitting unit 71 and the light receiving unit 72 in the up-down direction. The light passing sections 114a and 114b are disposed in, in the direction along the X axis, a region where the first sheet metal 111 and the second sheet metal 112 are superimposed. Compared with when the light passing sections 114a and 114b are disposed in a region where the first sheet metal 111 and the second sheet metal 112 are not superimposed, a decrease in strength can be suppressed.

The disposition of the light passing sections 114a and 114b in the direction along the X axis is not limited to the above. The light passing sections 114a and 114b may be disposed in the medium holding unit 113 or may be disposed across the medium holding unit 113 and the region where the first sheet metal 111 and the second sheet metal 112 are superimposed. However, when a part or the entire light passing sections 114a and 114b are disposed in the medium holding units 113, the medium M needs to be held so as not to overlap the light passing sections 114a and 114b.

The light passing sections 114a and 114b are openings penetrating the first sheet metal 111 and the second sheet metal 112 and are rectangular when viewed from the +Z direction. The light passing sections 114a and 114b are disposed at positions overlapping the recess 51 in the up-down direction. That is, since the light passing sections 114a and 114b are disposed, in the up-down direction, at positions overlapping the light passing region and allow the irradiation light emitted from the light emitting unit 71 to pass to the light passing region, the light passing sections 114a and 114b do not reflect the reflected light to the light receiving unit 72. The plurality of light passing sections 114a and 114b, which are openings, are provided in the direction along the X axis, which is the intersection direction. The irradiation light emitted from the optical sensor 70 that performs scanning in the direction along the X axis, which is the intersection direction, and for detecting the detection object on the support surface 50a passes the light passing sections 114a and 114b and travels in the -Z direction. Accordingly, compared with a form in which there is one opening, it is easier to recognize a place where the medium pressing member 100 is disposed and it is possible to accurately detect the positions of the medium holding units 113. The form and the number of the light passing sections 114a and 114b are not limited to the above.

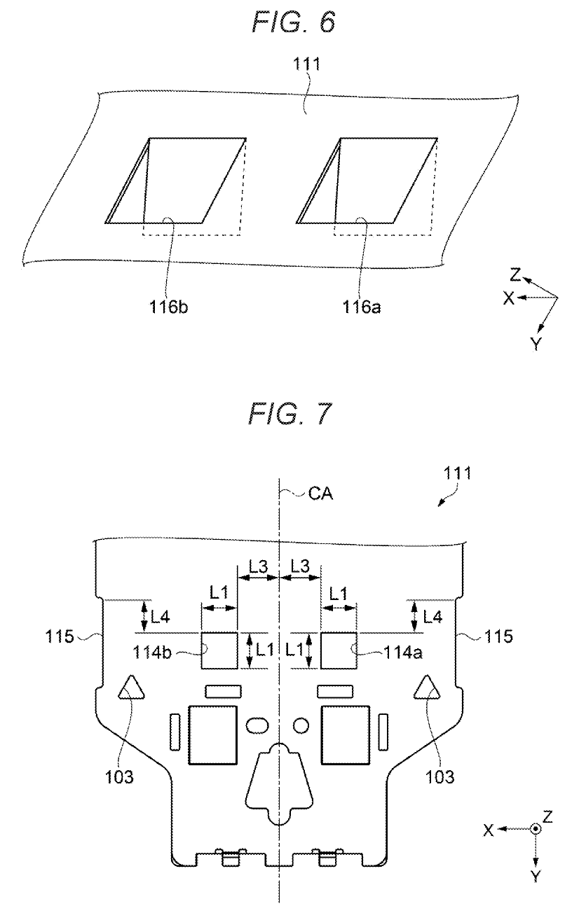

Here, as illustrated in FIG. 6, light passing sections 116a and 116b may be applied instead of the light passing sections 114a and 114b. The light passing sections 116a and 116b may be openings formed by bending a part of the first sheet metal 111 or the second sheet metal 112. Specifically, the light passing sections 116a and 116b are the same rectangular openings as the light passing sections 114a and 114b when viewed from the +Z direction but are not through holes like the light passing sections 114a and 114b. The light passing sections 116a and 116b are formed by bending a side along the X axis of a part of the first sheet metal 111 or the second sheet metal 112 in the -Z direction. When viewed from the -X direction, the irradiation light of the light emitting unit 71 passes the light passing sections 116a and 116b, is reflected by a part of the bent first sheet metal 111 or second sheet metal 112, and travels to other than the light receiving unit 72. Since the light passing sections 116a and 116b are not formed as through holes, it is possible to save time and effort required for machining.

Referring back to FIGS. 4 and 5, the medium holding units 113 include reference sections 115. The reference sections 115 are notches provided in the first sheet metal 111. The reference sections 115 serve as starting points at the time when the medium holding units 113 are detected while the light emitting unit 71 and the light receiving unit 72 explained above performing scanning along the X axis. One reference section 115 is formed on each of the side at the end portion in the +X direction and the side at the end portion in the -X direction in the first sheet metal 111 configuring the medium holding units 113.

Specifically, the reference sections 115 are provided in parts corresponding to scanning ranges of the light emitting unit 71 and the light receiving unit 72 of the optical sensor 70 in the medium holding units 113. That is, the two reference sections 115 and the light passing sections 114a and 114b are present at overlapping positions in the direction along the X axis, which is the intersection direction.

Since the reference sections 115 serve as the starting points at the time when the medium holding units 113 are detected, it is possible to accurately specify the positions of the medium holding units 113 in the direction along the X axis by accurately forming the reference sections 115 in the medium holding units 113. In other words, in the medium holding units 113, in parts other than the reference sections 115, for example, in regions outside the scanning ranges of the light emitting unit 71 and the light receiving unit 72, it is possible to set the accuracy of machining or molding relatively low and it is possible to reduce manufacturing cost of the medium pressing member 100.

The operation unit 101a is disposed at the end portion in the +Y direction of the main body unit 101. The operation unit 101a has a substantially rectangular parallelepiped shape. The operation unit 101a includes two disengagement units 105.

The main body unit 101 can be engaged with the medium support unit 50 by the first engagement unit 106 and the two second engagement units 109. The first engagement unit 106 engages with the medium support unit 50 but the movement of the first engagement unit 106 along the X axis is not restricted. The two second engagement units 109 engage with the medium support unit 50 and the movement of the two second engagement units 109 along the X axis is restricted.

The two disengagement units 105 release the engagement of the two second engagement units 109 with the medium support unit 50. Specifically, the disengagement units 105 are respectively disposed on a side surface facing the +X direction and a side surface facing the -X direction of the operation unit 101a. The disengagement units 105 are coupled to the second engagement unit 109 protruding from the second sheet metal 112 in the -Z direction. By gripping the two disengagement units 105 with a hand and pushing the two disengagement units 105 into the side surfaces, the two second engagement units 109 are displaced and the engagement of the two second engagement units 109 and the medium support unit 50 is released. In a state in which the engagement is released, it is possible to move the medium pressing member 100 in the +X direction or the -X direction with respect to the support surface 50a of the medium support unit 50. Accordingly, it is possible to adjust a position where the medium M is pressed by the medium pressing member 100 in the direction along the X axis.

The first sheet metal 111 includes four guide holes 103 and a bent section 108. The four guide holes 103 are triangular through holes. The guide holes 103 serve as guides for positioning the end portion of the medium M with respect to the medium holding units 113 when the end portion of the medium M is sandwiched between the medium holding units 113 and the support surface 50a. Two of the four guide holes 103 are disposed in the medium holding units 113 in the +X direction and the other two are disposed in the medium holding unit 113 in the -X direction. The two guide holes 103 are respectively provided to face each other in the direction along the Y axis.

The bent section 108 has a shape in which the end portion in the -Y direction of the first sheet metal 111 is bent in the +Z direction and a gap between the bent section 108 and the support surface 50a is widened. When the leading end portion in the conveyance direction of the medium M is nipped in the gap between the medium holding units 113 and the support surface 50a, the bent section 108 allows the medium M to easily enter the gap.

As illustrated in FIG. 7, the light passing section 114a and the light passing section 114b have a shape symmetric with respect to a center line CA of the first sheet metal 111 in the direction along the X axis and are symmetrically disposed. In the following explanation referring to FIG. 7, unless specifically noted otherwise, a state viewed from the +Z direction is explained. A form and disposition explained below of the light passing sections 114a and 114b are examples and are not limited thereto.

The width of the light passing sections 114a and 114b, which are the openings, in the direction along the X axis is larger than a spot diameter of the irradiation light at a detection position of the optical sensor 70. Accordingly, sufficient detection accuracy can be ensured even when the moving speed of the optical sensor 70 and the machining accuracy of the light passing sections 114a and 114b are considered.

Specifically, the light passing sections 114a and 114b are square and two opposite sides thereof extend along the X axis and the other two opposite sides thereof extend along the Y axis. In the light passing sections 114a and 114b, length L1 of each one side is 5.0 mm. In the present embodiment, the spot diameter of the irradiation light of the light emitting unit 71 is 3.0 mm with respect to the first sheet metal 111. The center of the circle of the irradiation light with which the first sheet metal 111 is irradiated can coincide with an intersection of diagonal lines of the respective light passing sections 114a and 114b.

The center line CA and the light passing sections 114a and 114b are separated from each other by length L3. The length L3 is 5.9 mm and the light passing sections 114a and 114b are separated from each other by 11.8 mm. Accordingly, the optical sensor 70 can sufficiently detect the light passing sections 114a and 114b with respect to a sampling period in the optical sensor 70 and moving speed of the head carriage 62.

In the direction along the Y axis, the light passing sections 114a and 114b are disposed apart from the end in the -Y direction of the reference section 115 by length L4. The length L4 is 4.5 mm.

Here, as a comparative example, a detection state of the optical sensor 70 with respect to a medium pressing member 300 of the related art is explained. The medium pressing member 300 of the related art has substantially the same shape as the medium pressing member 100 but does not include the light passing sections 114a and 114b and does not have metallic luster. Those not having metallic luster are, for example, a metal component applied with coating.

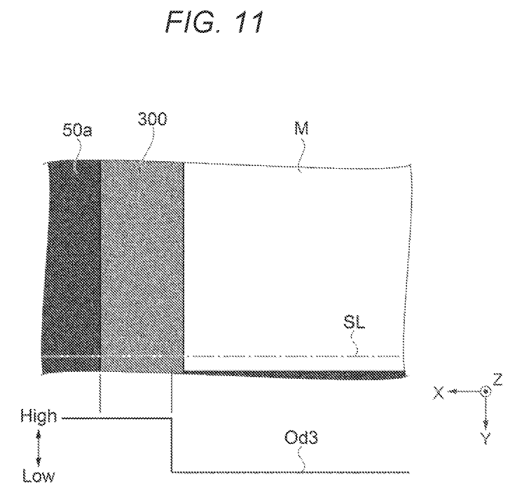

As illustrated in FIG. 11, when the medium M is pressed by the medium pressing member 300 and detection of the detection object is executed on the scanning line SL by the optical sensor 70, an output signal Od3 is obtained. Although not illustrated, the recess 51 explained above is provided at a position corresponding to the scanning line SL on the support surface 50a. In the optical sensor 70, a signal output to the control unit is lower as the intensity of the reflected light received by the light receiving unit 72 is larger and the signal output to the control unit is higher as the intensity of the reflected light is smaller.

The output signal Od3 is low in the medium M and is high in the medium pressing member 300 and the support surface 50a. This is because the medium M strongly reflects the irradiation light of the light emitting unit 71 and the recess 51 of the support surface 50a and the medium pressing member 300 do not reflect or weakly reflect the irradiation light.

Since the output signal Od3 has one change point, occurrence of erroneous detection, a detection error, and the like are concerned. When a recognition pattern is disposed on the scanning line SL of the medium pressing member 300, it is possible to obtain change points in a plurality of parts. However, it is likely that ink mist or dust adheres to make it difficult to read the recognition pattern. Depending on a type of ink, the recognition pattern or the coating of the medium pressing member 300 is sometimes deteriorated to induce erroneous detection of the optical sensor 70.

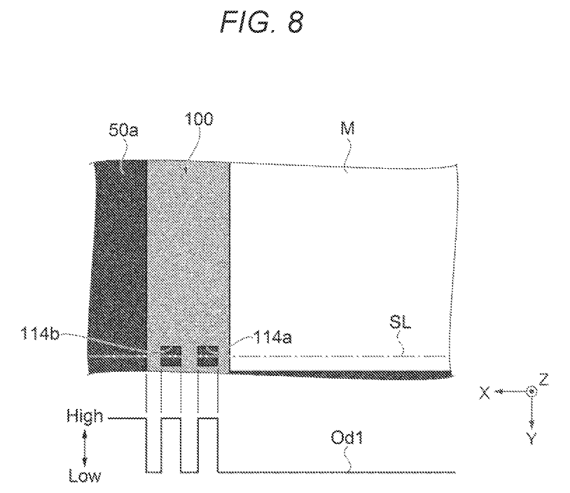

In contrast, as illustrated in FIG. 8, in the medium pressing member 100 in the present embodiment, the output signal Od1 is obtained. The output signal Od1 is low in the medium M and a region other than the light passing sections 114a and 114b of the medium pressing member 100 and is high in the light passing sections 114a and 114b and the support surface 50a.

This is because the irradiation light is less easily reflected toward the light receiving unit 72 in the light passing sections 114a and 114b and reflectance is large in the medium pressing member 100. Specifically, since the first sheet metal 111 explained above of the medium pressing member 100 has metallic luster, the reflectance is high. On the other hand, in the recess 51, reflected light toward the light receiving unit 72 is less easily generated irrespective of a color of the support surface 50a or presence or absence of coating. Therefore, a difference in reflectance stably increase between the medium pressing member 100 and the support surface 50a and occurrence of erroneous detection is suppressed. Since the metallic luster of the first sheet metal 111 derives from a material, deterioration such as coating peeling less easily occurs, which also contributes to a reduction in coating cost.

Since the light passing sections 114a and 114b are the two parts, change points of the output signal Od1 are five parts. Accordingly, for example, a threshold may be set to approximately the middle of levels of an output value and presence or absence of the medium pressing member 100 may be discriminated from the number of times the threshold is exceeded. It is possible to easily specify a printable region of the medium M from the positions of the light passing sections 114a and 114b.

Here, in FIGS. 8 and 11, the optical sensor 70 performs scanning in the -X direction from the end portion in the +X direction of the support surface 50a. Accordingly, in the medium M, a boundary of the printable region on the +X direction side is specified. When the boundary of the printable region on the -X direction side of the medium M is specified, the optical sensor 70 performs scanning in the +X direction from the end portion in the -X direction of the support surface 50a. Specifically, for example, the optical sensor 70 is moved in the +X direction from the end portion in the -X direction of the support surface 50a, and the optical sensor 70 is turned back and moved in the -X direction at the end portion in the +X direction of the support surface 50a. Although not particularly limited, both boundaries of the printable region may be detected by reciprocating the optical sensor 70 explained above.

According to the present embodiment, the following effects can be obtained.

Occurrence of erroneous detection in the optical sensor 70 can be suppressed. Specifically, in the scanning range of the optical sensor 70, the presence of the medium M serving as the detection object and the region other than the light passing sections 114a and 114b of the medium pressing member 100 is detected by the optical sensor 70. In other words, when the detection object is present in the scanning range, the optical sensor 70 receives reflected light of the irradiation light reflected by the detection object. In contrast, since the detection object is absent on the support surface 50a in the light passing sections 114a and 114b, the optical sensor 70 less easily receives the reflected light from the detection object and the intensity of the reflected light changes. That is, the optical sensor 70 specifies the presence or absence and the position of the detection object from the change in the intensity of the reflected light. For that reason, compared with the configuration of the related art in which the recognition pattern is detected, the detection is less easily affected by stains. Therefore, it is possible to provide the medium pressing member 100 and the printing apparatus 1 that suppress occurrence of erroneous detection in the optical sensor 70.

### 2. Second Embodiment

In the present embodiment, a medium pressing member 200 is exemplified instead of the medium pressing member 100 in the embodiment explained above. In the medium pressing member 200, the form of the light passing sections 114a and 114b is changed with respect to the medium pressing member 100 in the embodiment. The same components as the components of the medium pressing member 100 are denoted by the same reference numerals and signs and redundant explanation of the components is omitted.

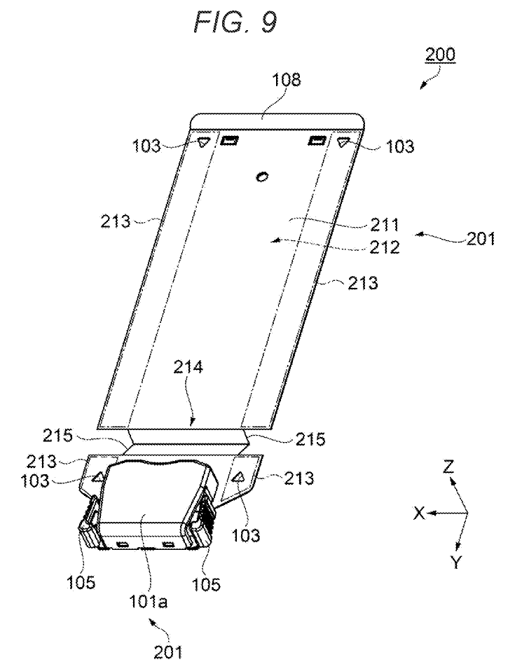

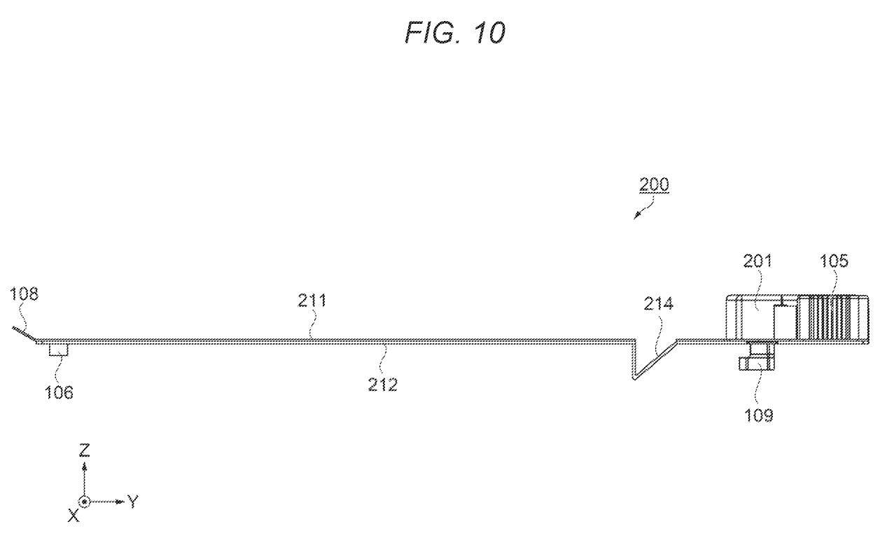

As illustrated in FIGS. 9 and 10, the medium pressing member 200 includes a main body unit 201, the guide holes 103, the disengagement units 105, and medium holding units 213. The main body unit 201 includes a third sheet metal 211 and a fourth sheet metal 212 made of metal and the operation unit 101a attached to the third sheet metal 211 and the fourth sheet metal 212. The main body unit 201 supports the medium holding units 213. The medium holding units 213 or the main body unit 201 includes a light passing section 214. In the present embodiment, the light passing section 214 is provided in the main body unit 201.

The third sheet metal 211 and the fourth sheet metal 212 have a shape elongated in the direction along the Y axis when viewed from the +Z direction. The third sheet metal 211 and the fourth sheet metal 212 are metal plates having metallic luster and reflect irradiation light of the light emitting unit 71. The third sheet metal 211 and the fourth sheet metal 212 are formed of metal such as stainless steel or aluminum.

The third sheet metal 211 and the fourth sheet metal 212 overlap each other in the direction along the Z axis. The fourth sheet metal 212 is overlapped in the -Z direction of the third sheet metal 211. Since the third sheet metal 211 and the fourth sheet metal 212 are overlapped, the mechanical strength of the medium pressing member 200 is improved.

When viewed from the +Z direction, the fourth sheet metal 212 is smaller than the third sheet metal 211. Specifically, in the direction along the Y axis, the length of the third sheet metal 211 and the length of the fourth sheet metal 212 are substantially equal. In the direction along the X axis, which is the intersection direction, the width of the fourth sheet metal 212 is smaller than the width of the third sheet metal 211.

For that reason, when viewed from the -Z direction, regions that do not overlap the fourth sheet metal 212 are respectively present near a side in the -X direction and near the side in the +X direction of the third sheet metal 211. The regions are the medium holding units 213. That is, the medium pressing member 200 includes the medium holding units 213 on both the sides in the direction along the X axis. The medium holding unit 213 in the -X direction and the medium holding unit 213 in the +X direction are symmetric with respect to a straight line along the Y axis.

The medium holding unit 213 is not provided on both the sides of the light passing section 214 explained below in the direction along the X axis. That is, in the medium pressing member 200, the medium holding units 213 are not irradiated with the irradiation light of the optical sensor 70 and the detection object is only the medium M.

The width of the third sheet metal 211 in the direction along the X axis and the width of the fourth sheet metal 212 in the direction along the Y axis do not need to have the relationship explained above over the entire region in the direction along the Y axis. Specifically, the relationship explained above only has to hold at least in a region facing a scanning range of the head 61 in the up-down direction. In addition, in a region other than the facing region explained above, a part where the width of the fourth sheet metal 212 in the direction along the X axis is larger than the width of the third sheet metal 211 may be present.

The medium holding units 213 are formed of the third sheet metal 211. The medium holding units 213 press and hold the end portion of the medium M in the direction along the X axis to sandwich the end portion between the medium holding units 213 and the support surface 50a. Specifically, in the medium holding unit 213, since the fourth sheet metal 212 is not overlapped on the third sheet metal 211, the gap between the support surface 50a and the medium holding units 213 is larger by the thickness of the fourth sheet metal 212 compared with a part where the third sheet metal 211 and the fourth sheet metal 212 are superimposed. The medium M is sandwiched in the gap, and the medium M is pressed by the support surface 50a and the medium holding units 213. In other words, the medium M is sandwiched and held between the third sheet metal 211 and the support surface 50a. For that reason, it is possible to steadily hold the medium M with a relatively simple configuration.

The fourth sheet metal 212 guides the end face of the medium M in the direction along the X axis. Specifically, when the medium holding units 213 press the medium M, a side of the fourth sheet metal 212 in the direction along the X axis and a side at the end of the medium M in the direction along the X axis come into contact, whereby a part of the medium M is prevented from entering a region other than the medium holding units 213, that is, a region where the third sheet metal 211 and the fourth sheet metal 212 overlap. Accordingly, it is possible to easily and steadily perform positioning of the medium pressing member 200 with respect to the medium M in the direction along the X axis. When the medium M is pressed by the medium holding units 213, the side of the medium M and the side of the fourth sheet metal 212 may not come into contact.

The medium pressing member 200 is installed near both the ends of the support surface 50a in the direction along the X axis. For that reason, in the medium pressing member 200 installed in the -X direction of the support surface 50a, the medium M is pressed by the medium holding unit 213 on the +X direction side. In the medium pressing member 200 installed in the +X direction of the support surface 50a, the medium M is pressed by the medium holding units 213 on the -X direction side.

The medium pressing member 200 restricts the medium M from moving along the X axis but does not restrict the medium M from moving along the Y axis. That is, the medium M can be conveyed in the direction along the Y axis while being pressed by the medium pressing member 200.

The light passing section 214 is provided at a position facing the light emitting unit 71 and the light receiving unit 72 in the up-down direction in the third sheet metal 211. The light passing section 214 is formed of a sheet metal, is bent along the shape of the not-illustrated support surface 50a, and is formed to avoid the irradiation light of the optical sensor 70. Specifically, when viewed from the +X direction, the light passing section 214 is bent in a shape along the recess 51 explained above. Accordingly, in the light passing section 214, the irradiation light of the optical sensor 70 passes further in the -Z direction than the support surface 50a, and the irradiation light is not reflected to the light receiving unit 72.

In the light passing section 214, the dimension in the direction along the Z axis is formed thick with respect to the third sheet metal 211 in a region other than the fourth sheet metal 212 and the light passing section 214. Accordingly, in the light passing section 214, mechanical strength for connecting the third sheet metal 211 in the region other than the fourth sheet metal 212 and the light passing section 214 is ensured in the -Y direction and the +Y direction. The light passing section 214 is not limited to being formed as a part of the third sheet metal 211 and may be formed as a part of the fourth sheet metal 212 or may be a member separate from the third sheet metal 211 and the fourth sheet metal 212.

In the medium pressing member 200, the fourth sheet metal 212 may be omitted. In this case, the ends in the +X direction and the -X direction of the third sheet metal 211 are bent in the +Z direction away from the support surface 50a. That is, the medium M is formed to be sandwiched between the medium holding units 213 of the third sheet metal 211 and the support surface 50a. Accordingly, even when the fourth sheet metal 212 is omitted, the medium M is easily nipped between the support surface 50a and the medium holding units 213, and the medium pressing member 200 is easily set with respect to the medium M.

Reference sections 215 are provided in the +X direction and the -X direction of the light passing section 214. In order to avoid interference with the medium M when the medium M is pressed, the length of the reference section 215 in the direction along the X axis is set smaller than the length of the reference sections 115 in the embodiment explained above.

According to the present embodiment, the same effects as the effects of the embodiment explained above can be obtained.

What is claimed is:

1. A medium pressing member comprising:
a medium holding unit configured to press an end portion of a medium conveyed in a conveyance direction along a support surface of a medium support unit to sandwich, with the support surface, the end portion of the medium in an intersection direction intersecting the conveyance direction; and
a main body unit configured to support the medium holding unit and capable of engaging with the medium support unit, wherein
the medium holding unit or the main body unit includes a light passing section, and
irradiation light that is emitted from an optical sensor that performs scanning in the intersection direction and is for detecting a detection object on the support surface passes the light passing section.

2. The medium pressing member according to claim 1, wherein
the medium holding unit is formed of a first sheet metal,
the main body unit includes the first sheet metal and a second sheet metal overlapped on the first sheet metal, and
the light passing section is an opening penetrating the first sheet metal and the second sheet metal.

3. The medium pressing member according to claim 2, wherein
in the intersection direction, width of the second sheet metal is smaller than width of the first sheet metal, and
the second sheet metal guides an end face of the medium.

4. The medium pressing member according to claim 2, wherein the light passing section is formed by bending a part of the first sheet metal or the second sheet metal.

5. The medium pressing member according to claim 1, wherein
the medium holding unit includes a reference section provided in a part corresponding to a scanning range of the optical sensor, and
in the intersection direction,
the reference section and the light passing section are present at overlapping positions, and
the reference section is formed at an end portion of the medium holding unit.

6. The medium pressing member according to claim 1, wherein the light passing section is formed of a sheet metal and is formed to be bent along a shape of the support surface to avoid the irradiation light.

7. The medium pressing member according to claim 6, wherein
the medium holding unit is formed of a third sheet metal,
the main body unit includes the third sheet metal and a fourth sheet metal overlapped on the third sheet metal, and
the medium is sandwiched and held between the third sheet metal and the support surface.

8. The medium pressing member according to claim 6, wherein the medium holding unit is formed such that the sheet metal is bent in a direction away from the support surface and the medium is sandwiched between the sheet metal and the support surface.

9. A printing apparatus comprising:
a medium support unit configured to support, on a support surface, a medium conveyed in a conveyance direction;
a head configured to discharge liquid onto the medium supported on the support surface;
a head carriage configured to move the head in an intersection direction intersecting the conveyance direction;
an optical sensor mounted on the head carriage and performs scanning in the intersection direction to detect a detection object on the support surface; and
a medium pressing member including a medium holding unit configured to press an end portion of the medium in the intersection direction to sandwich the end portion with the support surface and a main body unit configured to support the medium holding unit and capable of engaging with the medium support unit, wherein
the medium holding unit or the main body unit includes a light passing section configured to allow irradiation light of the optical sensor to pass.

10. The printing apparatus according to claim 9, wherein the medium support unit includes a recess at a position overlapping the light passing section.

11. The printing apparatus according to claim 10, wherein
the recess is a groove extending along the intersection direction, and
the optical sensor performs scanning along the recess.

12. The printing apparatus according to claim 11, wherein, in the groove, a part irradiated with the irradiation light includes a surface extending in a direction intersecting an irradiation direction of the irradiation light.

13. The printing apparatus according to claim 9, wherein the light passing section is an opening.

14. The printing apparatus according to claim 13, wherein the opening is formed at width larger than a spot diameter of the irradiation light at a detection position of the optical sensor.

15. The printing apparatus according to claim 13, wherein a plurality of the openings are provided along the intersection direction.
